(19) United States
(12) Patent Application Publication
(10) Pub. No.: US 2006/0245816 A1
(43) Pub. Date: Nov. 2, 2006

(54) Fabric cleaning article

(75) Inventors: Cecelia Mary Berger Sharp, Atlanta, GA (US); Michael S. Brunner, Roswell, GA (US); Laura Elizabeth Keck, Alpharetta, GA (US)

Correspondence Address: KIMBERLY-CLARK WORLDWIDE, INC., 401 NORTH LAKE STREET, NEENAH, WI, 54956, US

(73) Assignee: Kimberly-Clark Worldwide, Inc.

(21) Appl. No.: 11/118,979

(22) Filed: Apr. 29, 2005

(51) Int. Cl. B43K 5/14; B43K 5/00

(52) U.S. Cl. 401/132; 401/205

(57) ABSTRACT

The invention relates to a fabric cleaning article highly suited for household, commercial or industrial cleaning of fabrics which have become soiled or stained. The fabric cleaning article may desirably be used to remove spots or stains from such fabrics as clothing, upholstery and carpeting, etc., and provides for mess-free and convenient all-in-one cleaning. The fabric cleaning article includes a reservoir containing a cleaning composition for removing spots or stains, and at least a first absorbent layer secured or attached to a liquid barrier layer which keeps a user's hands and/or shoes isolated from liquids involved in the spill and from the cleaning composition.

### BACKGROUND OF THE INVENTION

There are a variety of products known for cleaning fabrics, such as clothing, upholstery, carpeting and rugs. Some of these products are designed specifically for cleaning spots, spills or stains, for example, small or discretely located/isolated soiled areas of the fabric. Such small spills and stains routinely occur as a result of accidental spills of food, drink and other household substances, pet accidents, etc. By way of example, there are products available for cleaning spots, spills or stains from carpet or upholstery which are available in the form of a spray bottle for spraying of a cleaning liquid onto the spotted area.

However, these spray cleaners typically require the user, after application of the cleaning liquid, to separately obtain some type of absorbent material (e.g., paper towels, cloth towels and the like) for soaking up the cleaning liquid and any loosened material coming from the spot or spill. In addition, the user must press the absorbent material onto the fabric to absorb the cleaning liquid and loosened spot from out of the fabric being cleaned, which may result in the user's hands or apparel becoming soiled with the cleaning liquid and/or material from the spot or spill.

Therefore, there exists a continuing need for an all-in-one fabric cleaner or fabric cleaning article capable of providing or delivering a fabric cleaning composition to the area to be cleaned on the fabric, and further capable of removing or absorbing up the cleaning composition and the loosened material making up the spot, stain or spill, all the while protecting the user of the fabric cleaning article from contact with the cleaning composition and/or the material of the spot, stain or spill.

### SUMMARY OF THE INVENTION

The present invention provides a convenient, all-in-one fabric cleaning article. The fabric cleaning article of the invention provides a convenient all-in-one cleaning kit for the removal or cleaning of spills, spots and stains from fabrics, such as clothing, upholstery, carpets and rugs, etc., that have become soiled. The fabric cleaning article includes at least a first absorbent layer having an upper surface and a lower surface, at least one reservoir adjacent the first absorbent layer, where the reservoir includes or contains a cleaning composition, and at least one liquid barrier layer. The reservoir may include a peel-away cover layer. The liquid barrier layer is secured to the upper surface of the first absorbent layer and is also secured to at least a portion of the reservoir.

In embodiments, the fabric cleaning article may include a second or additional absorbent layers secured to the liquid barrier layer, and one or more of the absorbent layers may desirably include a nonwoven web material. Such nonwoven web may desirably include cellulosic fibers and/or thermoplastic polymer fibers, for example such nonwoven webs may include coform materials, airlaid materials, and the like. The absorbent layer(s) may desirably include a facing layer, such as a nonwoven or film facing layer. Where additional absorbent layers are present, the additional absorbent layers may desirably be adjacent to the first absorbent layer in a side-by-side arrangement such that the liquid barrier layer secures to the upper surface of the second absorbent layer, and the fabric cleaning article may desirably be folded into a “Z” shaped configuration, or otherwise folded. Alternatively, an additional or second absorbent layer may be located above the first absorbent layer such that the liquid barrier layer is secured to the lower surface of the second absorbent layer (i.e., the liquid barrier layer between the two absorbent layers).

In other embodiments, the liquid barrier layer may include a first section and a second section, with the first section secured to the absorbent layers, and the second section of the liquid barrier layer being positionable or movable such that the second section may be positioned against either the lower surface of the first absorbent layer or the upper surface of a second absorbent layer.

### BRIEF DESCRIPTION OF THE DRAWINGS

FIG. 1 schematically illustrates in side view an exemplary embodiment of the fabric cleaning article of the invention.

FIG. 2 illustrates in bottom view another embodiment of the fabric cleaning article of the invention.

FIG. 3 illustrates in side view still another embodiment of the fabric cleaning article of the invention.

FIG. 4 illustrates in bottom view another embodiment of the fabric cleaning article of the invention.

FIG. 5 illustrates in side view still another embodiment of the fabric cleaning article of the invention.

### DEFINITIONS

As used herein and in the claims, the term “comprising” is inclusive or open-ended and does not exclude additional unrecited elements, compositional components, or method steps. Accordingly, the term “comprising” encompasses the more restrictive terms “consisting essentially of” and “consisting of”.

As used herein the term “polymer” generally includes but is not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the material. These configurations include, but are not limited to, isotactic, syndiotactic and random symmetries. As used herein the term “thermoplastic” or “thermoplastic polymer” refers to polymers that will soften and flow or melt when heat and/or pressure are applied, the changes being reversible.

As used herein the term “fibers” refers to both staple length fibers and substantially continuous filaments, unless otherwise indicated. As used herein the term “substantially continuous” with respect to a filament or fiber means a filament or fiber having a length much greater than its diameter, for example having a length to diameter ratio in excess of about 15,000 to 1, and desirably in excess of 50,000 to 1.

As used herein the term “monocomponent” fiber refers to a fiber formed from one or more extruders using only one polymer composition. This is not meant to exclude fibers or filaments formed from one polymeric extrudate to which small amounts of additives have been added for color, anti-static properties, lubrication, hydrophilicity, etc.

As used herein the term “multicomponent fibers” refers to fibers or filaments that have been formed from at least two component polymers, or the same polymer with different properties or additives, extruded from separate extruders but spun together to form one fiber or filament. Multicomponent fibers are also sometimes referred to as conjugate fibers or bicomponent fibers, although more than two components may be used. The polymers are arranged in substantially constantly positioned distinct zones across the cross-section of the multicomponent fibers and extend continuously along the length of the multicomponent fibers. The configuration of such a multicomponent fiber may be, for example, a concentric or eccentric sheath/core arrangement wherein one polymer is surrounded by another, or may be a side by side arrangement, an “islands-in-the-sea” arrangement, or arranged as pie-wedge shapes or as stripes on a round, oval or rectangular cross-section fiber, or other configurations. Multicomponent fibers are taught in U.S. Pat. No. 5,108,820 to Kaneko et al. and U.S. Pat. No. 5,336,552 to Strack et al. Conjugate fibers are also taught in U.S. Pat. No. 5,382,400 to Pike et al. and may be used to produced crimp in the fibers by using the differential rates of expansion and contraction of the two (or more) polymers. For two component fibers, the polymers may be present in ratios of 75/25, 50/50, 25/75 or any other desired ratios. In addition, any given component of a multicomponent fiber may desirably comprise two or more polymers as a multiconstituent blend component.

As used herein the terms “biconstituent fiber” or “multiconstituent fiber” refer to a fiber or filament formed from at least two polymers, or the same polymer with different properties or additives, extruded from the same extruder as a blend. Multiconstituent fibers do not have the polymer components arranged in substantially constantly positioned distinct zones across the cross-section of the multicomponent fibers; the polymer components may form fibrils or protofibrils that start and end at random.

As used herein the terms “nonwoven web” or “nonwoven fabric” refer to a web having a structure of individual fibers or filaments that are interlaid, but not in an identifiable manner as in a knitted or woven fabric. Nonwoven fabrics or webs have been formed from many processes such as for example, meltblowing processes, spunbonding processes, coforming processes, airlaying processes, and carded web processes. The basis weight of nonwoven fabrics is usually expressed in grams per square meter (gsm) or ounces of material per square yard (osy) and the fiber or filament diameters useful are usually expressed in microns. (Note that to convert from osy to gsm, multiply osy by 33.91).

The terms “spunbond” or “spunbond nonwoven web” refer to a nonwoven fiber or filament material of small diameter fibers that are formed by extruding molten thermoplastic polymer as fibers from a plurality of capillaries of a spinneret. The extruded fibers are cooled while being drawn by an eductive or other well known drawing mechanism. The drawn fibers are deposited or laid onto a forming surface in a generally random manner to form a loosely entangled fiber web, and then the laid fiber web is subjected to a bonding process to impart physical integrity and dimensional stability. The production of spunbond fabrics is disclosed, for example, in U.S. Pat. Nos. 4,340,563 to Appel et al., 3,692,618 to Dorschner et al., and 3,802,817 to Matsuki et al., all incorporated herein by reference in their entireties. Typically, spunbond fibers or filaments have a weight-per-unit-length in excess of about 1 denier and up to about 6 denier or higher, although both finer and heavier spunbond fibers can be produced. In terms of fiber diameter, spunbond fibers often have an average diameter of larger than 7 microns, and more particularly between about 10 and about 25 microns, and up to about 30 microns or more.

As used herein the term “meltblown fibers” means fibers or microfibers formed by extruding a molten thermoplastic material through a plurality of fine, usually circular, die capillaries as molten threads or filaments or fibers into converging high velocity gas (e.g. air) streams that attenuate the fibers of molten thermoplastic material to reduce their diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Buntin. Meltblown fibers may be continuous or discontinuous, are often smaller than 10 microns in average diameter and are frequently smaller than 7 or even 5 microns in average diameter, and are generally tacky when deposited onto a collecting surface.

As used herein, an “airlaid” web is a fibrous web structure formed primarily by a process by which bundles of small fibers having typical lengths ranging from about 3 to about 50 millimeters (mm) are separated and entrained in an air supply or air stream and then deposited onto a forming screen or other foraminous forming surface, usually with the assistance of a vacuum supply, in order to form a dry-laid fiber web. Typically following deposition the web is densified and/or bonded by such means as thermal bonding or adhesive bonding. Equipment for producing air-laid webs includes the Rando-Weber air-former machine available from Rando Corporation of New York and the Dan-Web rotary screen air-former machine available from Dan-Web Forming of Risskov, Denmark. Generally the web comprises cellulosic fibers such as those from fluff pulp that have been separated from a mat of fibers, such as by a hammermilling process, and may also include other fibers such as synthetic staple fibers or binder fibers, super absorbent materials, etc. “Cellulosic” fibers can include materials having cellulose as a major constituent, typically 50 percent by weight or more cellulose or a cellulose derivative, and includes such as cotton, typical wood pulps, non-woody cellulosic fibers, cellulose acetate, cellulose triacetate, rayon, thermomechanical wood pulp, chemical wood pulp, debonded chemical wood pulp, milkweed, and bacterial cellulose.

As used herein “carded webs” refers to nonwoven webs formed by carding processes as are known to those skilled in the art and further described, for example, in U.S. Pat. No. 4,488,928 to Alikhan and Schmidt which is incorporated herein in its entirety by reference. Briefly, carding processes involve starting with staple fibers in a bulky batt that is combed or otherwise treated to provide a web of generally uniform basis weight. Typically, the webs are thereafter bonded by such means as through-air bonding, thermal point bonding, adhesive bonding, and the like.

As used herein “coform” or “coform web” refers to nonwoven webs formed by a process in which at least one meltblown diehead is arranged near a chute or other delivery device through which other materials are added while the web is being formed. Such other materials as may be added include staple fibers, cellulosic fibers, and/or superabsorbent materials and the like. Coform processes are described in U.S. Pat. Nos. 4,818,464 to Lau and 4,100,324 to Anderson et al., the disclosures of which are incorporated herein by reference in their entirety.

As used herein, “thermal point bonding” involves passing a fabric or web of fibers or other sheet layer material to be bonded between a heated calender roll and an anvil roll. The calender roll is usually, though not always, patterned on its surface in some way so that the entire fabric is not bonded across its entire surface. As a result, various patterns for calender rolls have been developed for functional as well as aesthetic reasons. One example of a pattern has points and is the Hansen Pennings or “H&P” pattern with about a 30 percent bond area with about 200 bonds per square inch (about 31 bonds per square centimeter) as taught in U.S. Pat. No. 3,855,046 to Hansen and Pennings. The H&P pattern has square point or pin bonding areas wherein each pin has a side dimension of 0.038 inches (0.965 mm), a spacing of 0.070 inches (1.778 mm) between pins, and a depth of bonding of 0.023 inches (0.584 mm). The resulting pattern has a bonded area of about 29.5 percent. Another typical point bonding pattern is the expanded Hansen and Pennings or “EHP” bond pattern which produces a 15 percent bond area with a square pin having a side dimension of 0.037 inches (0.94 mm), a pin spacing of 0.097 inches (2.464 mm) and a depth of 0.039 inches (0.991 mm). Other common patterns include a high density diamond or “HDD pattern”, which comprises point bonds having about 460 pins per square inch (about 71 pins per square centimeter) for a bond area of about 15 percent to about 23 percent, a “Ramish” diamond pattern with repeating diamonds having a bond area of about 8 percent to about 14 percent and about 52 pins per square inch (about 8 pins per square centimeter) and a wire weave pattern looking as the name suggests, e.g. like a window screen. As still another example, the nonwoven web may be bonded with a point bonding method wherein the arrangement of the bond elements or bonding “pins” are arranged such that the pin elements have a greater dimension in the machine direction than in the cross-machine direction. Linear or rectangular-shaped pin elements with the major axis aligned substantially in the machine direction are examples of this. Alternatively, or in addition, useful bonding patterns may have pin elements arranged so as to leave machine direction running “lanes” or lines of unbonded or substantially unbonded regions running in the machine direction, so that the nonwoven web material has additional give or extensibility in the cross machine direction. Such bonding patterns as are described in U.S. Pat. No. 5,620,779 to Levy and McCormack, incorporated herein by reference in its entirety, may be useful, such as for example the “rib-knit” bonding pattern therein described. Typically, the percent bonding area varies from around 10 percent to around 30 percent or more of the area of the fabric or web. Another known thermal calendering bonding method is the “pattern unbonded” or “point unbonded” or “PUB” bonding as taught in U.S. Pat. No. 5,858,515 to Stokes et al., wherein continuous bonded areas define a plurality of discrete unbonded areas. Thermal bonding (point bonding or point-unbonding) imparts integrity to individual layers or webs by bonding fibers within the layer and/or for laminates of multiple layers, such thermal bonding holds the layers together to form a cohesive laminate material.

### DETAILED DESCRIPTION OF THE INVENTION

The present invention provides a convenient, all-in-one fabric cleaning article. The fabric cleaning article includes at least one reservoir which is capable of delivering a cleaning composition to a spot or stain on a fabric or other material which is desired to be cleaned. The fabric cleaning article also includes at least a first absorbent layer capable of absorbing some or, desirably, most of the applied cleaning composition and/or liquids forming a spill and/or dissolved or suspended fine particulate materials making up a spot or stain. The fabric cleaning article further includes at least one liquid barrier layer. The fabric cleaning article of the invention provides a convenient all-in-one cleaning kit for the removal or cleaning of spills, spots and stains from fabrics, such as clothing, upholstery and carpets, which have become soiled.

The invention will be described with reference to the following description and Figures which illustrate certain embodiments. It will be apparent to those skilled in the art that these embodiments do not represent the full scope of the invention which is broadly applicable in the form of variations and equivalents as may be embraced by the claims appended hereto. Furthermore, features described or illustrated as part of one embodiment may be used with another embodiment to yield still a further embodiment. It is intended that the scope of the claims extend to all such variations and equivalents. In addition, it should be noted that any given range presented herein is intended to include any and all lesser included ranges. For example, a range of from 45-90 would also include 50-90; 45-80; 46-89 and the like. Thus, the range of 95% to 99.999% also includes, for example, the ranges of 96% to 99.1%, 96.3% to 99.7%, and 99.91% to 99.999%, etc.

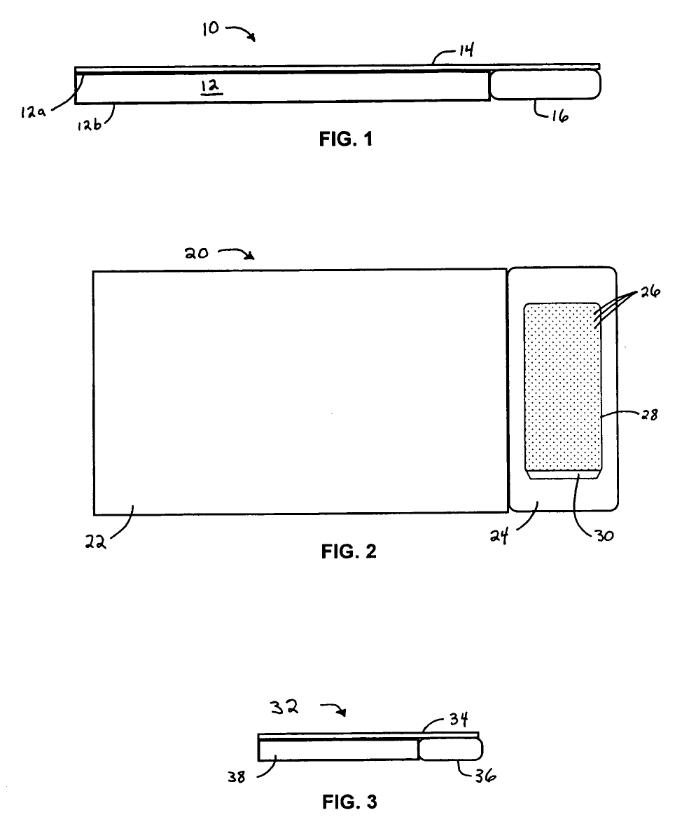

FIG. 1 schematically illustrates in side cross-sectional view an exemplary embodiment of the all-in-one fabric cleaning article of the invention. As shown in FIG. 1, the fabric cleaning article 10 includes a first absorbent layer 12 which has an upper surface 12a and a fabric-facing or lower surface 12b. The fabric cleaning article 10 further includes a liquid barrier layer 14 and a reservoir 16 adjacent or next to the first absorbent layer 12. Reservoir 16 contains a cleaning composition useful for removing soils, spills or stains from fabrics. By “adjacent”, what is meant is that the reservoir is to a side of the absorbent layer rather than being situated with the reservoir on top of the absorbent layer or with the absorbent layer on top of the reservoir. This arrangement prevents premature wetting of the first absorbent layer 12 with the cleaning composition, so that the cleaning composition is delivered primarily to the fabric to be cleaned. The liquid barrier layer 14 is secured to the upper surface 12a of the first absorbent layer 12. The liquid barrier layer 14 is also secured to the reservoir 16.

It should be noted that, although the liquid barrier layer is shown to be coextensive with the reservoir in the Figures, the liquid barrier layer does not necessarily need to extend all of the way across the width extent of the reservoir. For example, the liquid barrier layer may desirably only be attached or secured to the side of the reservoir nearest the absorbent layer. As still another alternative, the liquid barrier layer itself may actually form a portion of the reservoir, or may form the entire reservoir. For example, the liquid barrier layer and reservoir may be formed from a sheet of film material having one end folded over upon itself and sealed to form a cavity that becomes a reservoir.

When used in fabric cleaning, the fabric cleaning article may be employed as follows. The user places the fabric cleaning article over the spot or stain on the soiled fabric, and in particular locates the reservoir over the soiled area to be cleaned. The user then applies pressure to the back of (that is, the upper surface of) the fabric cleaning article over the reservoir area, such as by pressing with the hand or foot, to express the cleaning composition from the reservoir and deliver or deposit the cleaning composition onto and/or into the soiled fabric. The user then repositions the fabric cleaning article so that the absorbent layer is over the soiled area to be cleaned/area of cleaning composition deposition. Then, pressure may be applied with the hand or foot to the back or upper surface of the fabric cleaning article in order to cause the cleaning composition (along with any soil or stain particles the cleaning composition has loosened from the soiled area) to be absorbed up into the absorbent layer. Depending on the size of the absorbent layer and the amount of cleaning composition expressed to the fabric, the user may also adjust the positioning of the absorbent layer to center a dry or dryer portion of the absorbent layer over the spot area in order to absorb more of the cleaning composition. Because the fabric cleaning article includes a liquid barrier layer, the user of the product is beneficially protected from contact with the cleaning composition and/or the materials constituting the stain or spill.

The reservoir may be designed to burst open upon the application of pressure, for example as by having score lines partially through the reservoir material in the fabric-facing or lower side surface of the reservoir. For example, the reservoir may suitably be constructed of a film material, such as a thermoplastic polymeric film material, which may have score lines inscribed partially through the thickness of the film to provide weakened areas of the fabric-facing surface of the reservoir which open upon the application of a desired amount of pressure. However, it may also be desirable to have a reservoir with a pre-perforated fabric-facing surface as shown in the embodiment illustrated in FIG. 2.

FIG. 2 illustrates another embodiment of the fabric cleaning article. In FIG. 2, the fabric cleaning article 20 is shown in bottom view (viewing the fabric-facing side of the fabric cleaning article). The fabric cleaning article 20 includes the first absorbent layer 22 and reservoir 24 adjacent the first absorbent layer 22, which are both secured to the liquid barrier layer (not visible in FIG. 2). In the embodiment shown in FIG. 2, the fabric-facing surface of the reservoir 24 includes a plurality of perforations such as the plurality of pinholes 26 shown in FIG. 2. In order to avoid premature expression (or leakage) of the cleaning composition through pinholes 26, the portion of the reservoir 24 having pinholes 26 is desirably covered by a peel-away cover, such as the removably affixed tape material layer 28 shown in FIG. 2. Such a peel-away cover material may be coextensive with the fabric facing surface of the reservoir 24 or, as shown, cover only that portion of the fabric facing surface of the reservoir 24 having the pinholes 26. Peel-away cover layers may be constructed of any suitable material known in the art, such as adhesive films and tapes, adhesive pressure sensitive papers and labels, etc.

In addition, to make the cover material more easily removable by a user, such a peel-away tape material 28 may optionally include a grip-tab 30 as shown. The optional grip-tab 30 may be provided by the simple expedient of having a non-adhesive portion at an end of the peel-away cover material. As another alternative, the fabric-facing surface of the reservoir 24 may include a plurality of small circular or other shaped scored regions which, when the peel-away tape material 28 is removed, remain adhered to the tape material 28 and thereby provide openings in the reservoir 24 to allow the cleaning composition to pass therethrough. Such scored regions, pinholes or perforations and the like may be placed in the fabric facing surface of the reservoir by hand or may be produced by any suitable means known in the art such as by use of patterned rollers, pin aperturing with heated or unheated pin rollers, vacuum aperturing, and the like. In addition, it should be noted that the number and configuration of pinholes illustrated in FIG. 2 is merely exemplary, and it may be desirable to have a greater or fewer number of pinholes than shown, the pinholes may be arranged in differing patterns, etc.

In comparison to the above-mentioned score lines which burst open upon the application of pressure, pinholes 26 allow for more direct user control over the amount of cleaning composition deposited onto the fabric to be cleaned, and also allow for user control over the rate of cleaning composition deposition onto the fabric to be cleaned. That is, application of the cleaning composition via bursting open of weakened score lines tends to deposit all or nearly all of the cleaning composition at one time. However, when expressing the cleaning composition through the pinholes 26, the user may express the cleaning composition onto the fabric more slowly by using rather less pressure, or more quickly by using rather more pressure.

In addition, the pinholes may be configured in terms of number and pinhole diameter to deliver the cleaning composition in a desirable “jetting” action wherein, upon application of pressure, the user may express the cleaning composition from the pinholes in a relatively forceful stream of fluid that may penetrate deeply into the soiled or spotted fabric (e.g. carpet) being cleaned. Furthermore, such pinholes are desirable because a user may discontinue the application of pressure when a desired amount of cleaning composition has been expressed onto that portion of the fabric immediately being cleaned, thereby discontinuing the expression of cleaning composition, and move the reservoir to another area or spot to be cleaned and resume expressing of the cleaning composition by re-application of pressure. Alternatively, the user may re-cover the pinholes 26 by re-applying the peel-away tape material 28 and store the fabric cleaning article for further use.

The amount and type of cleaning composition provided in the reservoir of the fabric cleaning article will depend on the type of cleaning desired, fabric type, foreseeable types and sizes of cleaning jobs, etc. Generally, the cleaning composition will be a fluid composition such as, for example, an aqueous or water-based cleaning composition such as is known in the art which may contain soaps, detergents, surfactants, alcohols and/or other solvents and the like. Alternatively, the cleaning composition may be or include one or more non-aqueous compositions, such as solvents generally utilized in “dry” cleaning of fabrics, or may be primarily alcohol based, etc. As stated, the amount of cleaning composition provided will depend on the type of cleaning envisioned for a particular embodiment of the fabric cleaning article, and also depend on the overall size of the fabric cleaning article. For example, in FIG. 3 is shown a fabric cleaning article 32 which is similar to the fabric cleaning article 10 shown in FIG. 1, except smaller, and which includes a first absorbent layer 38, liquid barrier layer 34 and reservoir 36 adjacent the first absorbent layer 38. Using the two fabric cleaning articles 10 and 32 for descriptive comparison, the embodiment of the fabric cleaning article 10 shown in FIG. 1 may be desirably used for larger spills or stains on carpets and upholstery and the like, while the embodiment of the fabric cleaning article 32 shown in FIG. 3 may be desirably used for relatively smaller spills or stains on carpets and upholstery, and may also be desirably be used for spot-cleaning of small spills or stains on clothing. By way of non-limiting example only, the reservoir 36 of the fabric cleaning article 32 in FIG. 3 may desirably include as little as 2 to 10 milliliters of cleaning composition, while the reservoir 16 of the fabric cleaning article 10 in FIG. 1 may desirably include 10 or more milliliters of cleaning composition, or 25 or more milliliters of cleaning composition, 50 milliliters or more, 75 milliliters or more, etc.

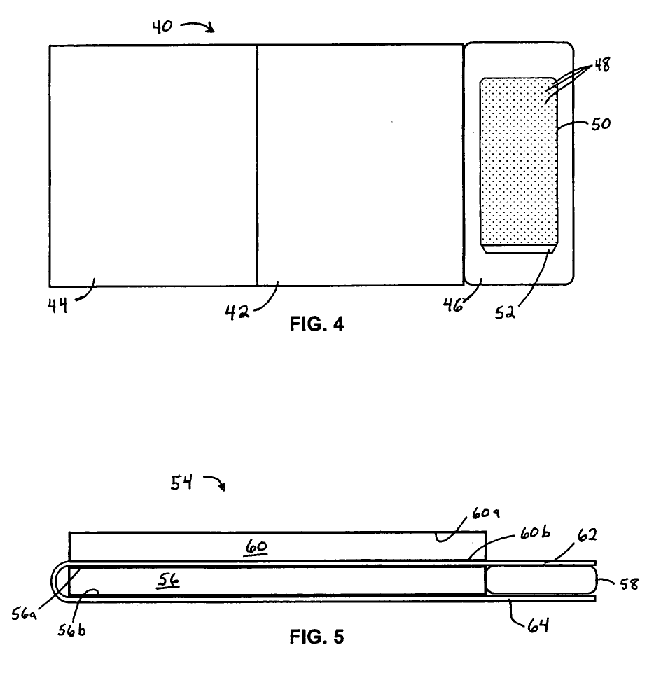

Still other alternatives are possible. For example, in other embodiments the fabric cleaning article may have a second absorbent layer or even a third absorbent layer. FIG. 4 illustrates a fabric cleaning article 40 having a first absorbent layer 42 and a second absorbent layer 44 arranged as adjacent or side-by-side panels and which are both secured to the liquid barrier layer (not visible in FIG. 4). The fabric cleaning article 40 further includes a reservoir 46 adjacent the first absorbent layer 42, and the reservoir 46 is configured similarly to reservoir 24 in FIG. 2; i.e., having pinholes 48 in the fabric-facing surface of the reservoir 46 which are covered by a peel-away cover layer 50, which includes a grip-tab 52. The fabric cleaning article 40 as shown in FIG. 4 may desirably be provided in a compact package in a convenient folded configuration. For example, the fabric cleaning article 40 may be provided in a tri-fold or “Z-fold” configuration wherein the second absorbent layer 44 is folded back behind the first absorbent layer 42 (so that the liquid barrier layer contacts itself), and the reservoir 46 is folded across over the fabric-facing surface of the first absorbent layer 42 (in this case, a reverse Z-fold configuration). Such a folded configuration advantageously provides a neat and compact configuration that may be preferred compared to a flat configuration for transport, storage and in-store or on-shelf display.

The multiple absorbent pad construction shown in FIG. 4 may desirably provide multi-cycle cleaning, as where a user expresses a portion of the cleaning composition from the reservoir 46 and absorbs as much of the cleaning composition (and loosened or dissolved stain/spot material) as possible with one of the first absorbent layer 42 or second absorbent layer 44. Then the user may express a second portion of the cleaning composition from the reservoir 46 for further cleaning, and absorb this second portion of cleaning composition and/or additional loosened stain or spot material. Alternatively, a user may utilize one of the absorbent layers to blot up or absorb the major portion of a recent liquid spill, then use the other absorbent layer in conjunction with the cleaning composition from the reservoir to assist in removing the remainder of the spill or stain. In any case, the two separate absorbent layers 42 and 44 may be essentially the same type of absorbent material with similar properties, or alternatively may be different absorbent materials with different properties such as different absorbencies, surface textures, basis weights, and the like. In addition, it should be noted that the multiple absorbent pad construction shown in FIG. 4 could be rearranged, for example the reservoir in FIG. 4 could be placed between the two absorbent layers instead of having the absorbent layers side-by-side.

Another alternative fabric cleaning article having more than one absorbent layer is shown in side view in FIG. 5. In FIG. 5, the fabric cleaning article 54 includes a first absorbent layer 56 having an upper surface 56a and a fabric-facing or lower surface 56b, and the fabric cleaning article 54 includes a reservoir 58. The fabric cleaning article 54 also includes a second absorbent layer 60 having a fabric-facing or upper surface 60a and a lower surface 60b. The fabric cleaning article 54 further includes a liquid barrier layer having a first section 62 positioned between the first absorbent layer 56 and second absorbent layer 60, and the liquid barrier layer has a second section 64 which as shown wraps around one end of the first absorbent layer 56 and rests against the fabric-facing or lower surface 56b of the first absorbent layer 56. The upper surface 56a of first absorbent layer 56 and the lower surface 60b of the second absorbent layer 60 are each attached or secured to the first section 62 of the liquid barrier layer. However, the second section 64 of the liquid barrier layer, which is shown resting against the fabric-facing or lower surface 56b of the first absorbent layer 56, is not attached to lower surface 56b and therefore is positionable against the non-secured surface of either of the two absorbent layers. That is, the second section 64 of the liquid barrier layer is movable, and may be folded or flipped over by the user to rest against the upper surface 60a of second absorbent layer 60 when desired.

As above with FIG. 4, the multi-absorbent pad construction shown in the fabric cleaning article 54 of FIG. 5 may desirably provide multi-cycle cleaning, as where a user expresses a portion of the cleaning composition from the reservoir 58 and absorbs as much of the cleaning composition (and loosened or dissolved stain/spot material) as possible with the first absorbent layer 56 (during this use, the second section 64 of the liquid barrier layer may be pulled out from under the fabric-facing or lower surface 56b of the first absorbent layer 56 and either laid out flat along a horizontal line with the fabric cleaning article, or folded around on top of the fabric cleaning article 54 to rest upon the upper surface 60a of second absorbent layer 60). Then, as described above, the user may express additional amounts of the cleaning composition for further cleaning, and absorb this additional portion of cleaning composition and/or additional loosened stain or spot material by flipping the fabric cleaning article over and utilizing the second absorbent layer 60, by pressing the upper surface or (now) fabric facing surface 60a against the treated spot or stain.

Desirably, prior to pressing the second absorbent layer 60 against the stain or spot, the user may fold the second section 64 of the liquid barrier layer back to cover the lower surface 56b of the first absorbent layer 56, thereby protecting the user from contact with the cleaning composition and/or spot or stain material which has been absorbed by first absorbent layer 56. In addition, or alternatively, as was described above with respect to FIG. 4, a user may employ one of the absorbent layers to first blot up or absorb the major portion of a recent liquid spill, prior to expression of any cleaning composition from the reservoir 58. Typically, the second absorbent layer 60 would be selected for initial blotting. Then, the user may employ the other absorbent layer (typically, the first absorbent layer 56) in conjunction with the cleaning composition from the reservoir to assist in removing the remainder of the spill or stain. In any case, as was stated above, the two separate absorbent layers 56 and 60 may be essentially the same type of absorbent material with similar properties, or alternatively may be different absorbent materials with different properties such as different absorbencies, surface textures, basis weights, and the like.

The first absorbent layer and/or any second absorbent layer or additional absorbent layers used in the fabric cleaning article may be any suitable absorbent material capable of soaking or blotting up the cleaning composition and/or spills, including woven or knitted cloth material layers, sponge or absorbent foam material layers, or nonwoven fibrous web materials. However, due to ease of manufacture and relative inexpense, fibrous nonwoven webs may be particularly suited for the absorbent layer(s) in the fabric cleaning article. Exemplary nonwoven web layers suitable for use include spunbond webs, meltblown webs, coform webs, hydroentangled webs, airlaid webs and carded webs as are known in the art and as are described above. Because of their relatively high levels of absorbency, particularly suitable nonwoven fibrous webs include coform and airlaid webs that are produced having pulp or other cellulosic fibers incorporated therein.

As mentioned above, coform webs are generally a composite of thermoplastic meltblown fibers and some secondary material, wherein the secondary material (such as pulp or other cellulosic materials) are added via a chute directly into the meltblown web as the fibers are being extruded and formed. Coforming processes and coform webs are further described in U.S. Pat. No. 5,350,624 to Georger et al., incorporated herein by reference, and in the above-mentioned U.S. Pat. No. 4,818,464 to Lau and U.S. Pat. No. 4,100,324 to Anderson et al. Airlaid webs and air-laying processes are also well known in the art; briefly, formation of airlaid webs involves deposition of loose, air-entrained fibers (generally, cellulosic fibers) onto a porous forming surface, and may also include longer fibers such as synthetic staple fibers or binder fibers. Typically, following collection of the fibers on the forming surface the airlaid web is bonded and/or may be densified by such means as thermal bonding or adhesive bonding. Airlaid webs and airlaying are disclosed for example in U.S. Pat. No. 4,640,810 to Laursen et al., U.S. Pat. No. 4,494,278 to Kroyer et al., U.S. Pat. No. 5,527,171 to Soerensen and U.S. Pat. No. 4,375,448 to Appel et al., each of which is herein incorporated by reference in its entirety.

In addition, any such nonwoven webs as are used for the absorbent layer(s) may be produced having optional super absorbent materials incorporated therein to increase the absorbency of the absorbent layer. As known in the art, examples of synthetic superabsorbent material polymers include poly(acrylic acid) and poly(methacrylic acid), poly(acrylamides), poly(vinyl ethers), maleic anhydride copolymers with vinyl ethers and alpha-olefins, poly(vinyl pyrrolidone), poly(vinylmorpholinone), poly(vinyl alcohol), and mixtures and copolymers thereof. Further superabsorbent materials include natural and modified natural polymers, such as hydrolyzed acrylonitrile- and acrylic acid-grafted starches, methyl cellulose, chitosan, carboxymethyl cellulose, hydroxypropyl cellulose, and the natural gums, such as alginates, xanthan gum, locust bean gum and the like.

Generally speaking, the basis weight of the first absorbent layer and/or of optional additional absorbent layers may suitably be from about 7 gsm or less up to about 400 gsm or even more, and more particularly may have a basis weight from about 34 gsm to about 350 gsm, and still more particularly, from about 68 gsm to about 300 gsm. Other examples are of course possible, and the desired basis weight of the first absorbent layer and/or additional absorbent layers will depend on a number of factors including the amount of cleaning composition provided, number and composition of absorbent layers provided, and recommended use for a particular embodiment of the fabric cleaning article.

As stated above, the first absorbent layer and the liquid barrier layer are secured or bonded together. The absorbent layer(s) may desirably be secured or otherwise bonded to the liquid barrier layer by suitable methods known in the art. For example, where both the first absorbent layer and the liquid barrier layer include at least some thermoplastic materials, they may be secured together by thermal bonding or ultrasonic bonding. Such attachment or bonding may be coextensive with the materials or may be performed only around the perimeter of the materials. However, adhesive bonding, such as by hot melt adhesives as are known in the art, may be more desirable than thermal or ultrasonic bonding, either where both materials to be secured do not include suitable amounts of thermoplastic materials or where potential puncturing of the liquid barrier layer is of concern. Such adhesive bonding may also be performed by application of adhesive which is coextensive with the materials or may desirably be performed only around the perimeter of the materials.

As known in the art, adhesives may desirably be applied via spraying, slot coating and the like. Examples of suitable hot melt adhesives include styrene/rubber block copolymers, polybutylene, EVA (ethylene/vinyl acetate copolymer), polyester, polyamide, or olefin based adhesives. Commercial examples of hot melt adhesives include those available from the Huntsman Polymer Corporation of Odessa, Texas under the names RT 2115, RT 2130, RT 2315, RT 2330 and RT 2730; those available from Bostick-Findley Corporation of Wauwatosa, Wash. under the names H2525A and H2096; and those available from National Starch and Chemical Company of Bridgewater, N.J. under the names NS5610 and NS34-2950. Other commercially available suitable adhesives include acrylic polymer emulsions available from the National Starch and Chemical Company and sold under the name DUR-O-SET®, and acrylic carboxylated latex polymer emulsions available from Noveon, Inc. of Cleveland, Ohio under the trade name HYCAR®.

The absorbent layer(s) used in constructing the fabric cleaning article may themselves desirably also include other or additional optional layers as a composite or laminate material. Such other web layers may be such as the spunbond, meltblown, coform, airlaid, and carded webs mentioned above, or may include film layers. As a particular example, the first absorbent layer may desirably be a pulp-meltblown coform web having a spunbond facing layer on its lower surface. Such an additional layer may be selected in order to prevent “linting” or fibrous deposition from the absorbent layer onto the fabric that is being cleaned. Such a facing layer may also serve as a texturized surface or mild scrubbing layer that also allows for the first absorbent layer to be scrubbed back and forth, if the user should so desire, without undue linting of the fibers of the first absorbent layer.

As another example, a film layer that has been perforated to allow for liquid passage may be laminated onto the lower surface of the first absorbent layer to prevent “linting” or fibrous deposition from the absorbent layer onto the fabric that is being cleaned. Such a laminate or composite may be produced by laminating the additional layer or layers to the absorbent layer by methods as are known in the art, including such as thermal bonding, ultrasonic bonding, adhesive bonding and the like. As still another example, a layer of relatively coarse meltblown fibers may be applied directly to an absorbent layer as a facing layer, to provide the above mentioned anti-linting and scrubbing texture features. The basis weight of such optional facing layers will desirably be as light as useful while still retaining the desired functionality; generally between about 7 gsm or less up to about 100 gsm or more, and more particularly between about 15 gsm and about 68 gsm.

The liquid barrier layer utilized in the construction of the fabric cleaning article of the invention must function as a barrier to the passage of liquids, so as to protect a user of the fabric cleaning article from fluids or liquids including the cleaning composition provided in the fabric cleaning article and spilled liquids which a user of the fabric cleaning article may desire to blot up or absorb. Examples of desirable liquid barrier layer materials include cast and blown polymeric film materials, metal foil materials and metalized polymer films. In addition, nonwoven web materials having liquid barrier properties such as spunbond-meltblown (“SM”) laminate layers and spunbond-meltblown-spunbond (“SMS”) laminate layers as are known in the art may be used. Such SM and SMS laminate materials are further described in U.S. Pat. Nos. 4,041,203 and 4,766,029 to Brock et al., 5,464,688 to Timmons et al. and 5,169,706 to Collier et al., all of which are incorporated herein by reference in their entireties. The basis weight of the liquid barrier layer may be from about 17 gsm or less up to 100 gsm or more; more particularly, a liquid barrier layer may have a basis weight from about 34 gsm or less to about 68 gsm.

The type and basis weight of the liquid barrier layer selected for a particular fabric cleaning article will depend on the desired use and usage of the fabric cleaning article. For example, where an embodiment of the fabric cleaning article is designed primarily for cleaning spots or spills on carpets or rugs, a tougher and heavier liquid barrier layer such as a heavier weight polymeric film material, capable of withstanding relatively rough pressing treatment from a user's shoe without tearing, and capable of maintaining its barrier properties even under relatively high applied pressures, should be selected. Generally speaking, the SM and SMS fibrous laminate materials mentioned above are capable of withstanding less applied pressure before allowing leakage than a polymeric film material of a similar basis weight.

As another example, where the cleaning composition is desirably a solvent material such as the organic solvents utilized in dry cleaning, a liquid barrier layer made from or including metal foil material or metalized polymer films may be more resistant to the solvents. In addition, the liquid barrier layer of any type may be treated with or incorporate a treatment chemistry making it more resistant to liquids, and particularly more resistant or more repellent to low surface tension fluids such as alcohols, ketones, surfactant-laden or soapy water, and the like. Examples of such treatment chemistries include fluoropolymer and silicone treatments as are known in the art.

The reservoir utilized in the fabric cleaning article of the invention needs to contain the cleaning composition provided with the fabric cleaning article until it is desired by the user to deliver the cleaning composition into or onto the fabric to be cleaned. As mentioned, such a cleaning composition will be a fluid composition such as, for example, an aqueous or water-based cleaning composition such as is known in the art which may contain soaps, detergents, anionic and/or cationic surfactants, and the like, and/or contain alcohols, and/or contain other solvents and the like. Alternatively, the cleaning composition may be or include one or more non-aqueous compositions, such as solvents generally utilized in “dry” cleaning of fabrics, or may be entirely alcohol based, etc.

For most applications, the material or materials for use in constructing the reservoir may desirably be polymeric films, such as thermoplastic polymeric films known in the art. Depending on type of cleaning composition, and particularly where dry cleaning type solvents are used, the material used in the reservoir should be resistant to chemical action or dissolution by the solvent, and resistant polymers or metalized foil films or metal films may be selected. The reservoir may desirably be a simple enclosed envelope capable of containing the cleaning composition, that is attached or secured to the liquid barrier layer, such as by use of one or more of the adhesives mentioned above. Of course, as was also mentioned above, the reservoir must be capable of delivering the cleaning composition to the fabric to be cleaned, such as by use of the pre-weakened or scored areas, or pinhole perforations, etc., that were mentioned above.

Polymers suitable for making thermoplastic fibrous elements in the absorbent layer(s) and/or the optional additional facing layers, and/or liquid barrier layers whether film or fibrous, and/or polymeric films for the reservoir, include those film- and fiber-forming polymers known to be generally suitable in the making of films and nonwoven webs such as spunbond, meltblown, coform, carded webs and the like, and include for example polyolefins, polyesters, polyamides, polycarbonates and copolymers and blends thereof. It should be noted that the polymer or polymers may desirably contain other additives such as processing aids or treatment compositions to impart desired properties to the fibers, residual amounts of solvents, pigments or colorants and the like.

Suitable polyolefins include polyethylene, e.g., high density polyethylene, medium density polyethylene, low density polyethylene and linear low density polyethylene; polypropylene, e.g., isotactic polypropylene, syndiotactic polypropylene, blends of isotactic polypropylene and atactic polypropylene; polybutylene, e.g., poly(1-butene) and poly(2-butene); polypentene, e.g., poly(1-pentene) and poly(2-pentene); poly(3-methyl-1-pentene); poly(4-methyl-1-pentene); and copolymers and blends thereof. Suitable copolymers include random and block copolymers prepared from two or more different unsaturated olefin monomers, such as ethylene/propylene and ethylene/butylene copolymers. Suitable polyamides include nylon 6, nylon 6/6, nylon 4/6, nylon 11, nylon 12, nylon 6/10, nylon 6/12, nylon 12/12, copolymers of caprolactam and alkylene oxide diamine, and the like, as well as blends and copolymers thereof. Suitable polyesters include poly(lactide) and poly(lactic acid) polymers as well as polyethylene terephthalate, polybutylene terephthalate, polytetramethylene terephthalate, polycyclohexylene-1,4-dimethylene terephthalate, and isophthalate copolymers thereof, as well as blends thereof.

Many elastomeric polymers are also known to be suitable as film and fiber-forming resins. Elastic polymers include, for example, elastic polyesters, elastic polyurethanes, elastic polyamides, elastic co-polymers of ethylene and at least one vinyl monomer, block copolymers, and elastic polyolefins. Examples of elastic block copolymers include those having the general formula A-B-A′ or A-B, where A and A′ are each a thermoplastic polymer endblock that contains a styrenic moiety such as a poly (vinyl arene) and where B is an elastomeric polymer midblock such as a conjugated diene or a lower alkene polymer such as for example polystyrene-poly(ethylene-butylene)-polystyrene block copolymers. Also included are polymers composed of an A-B-A-B tetrablock copolymer, as discussed in U.S. Pat. No. 5,332,613 to Taylor et al. An example of such a tetrablock copolymer is a styrene-poly(ethylene-propylene)-styrene-poly(ethylene-propylene) or SEPSEP block copolymer. These A-B-A′ and A-B-A-B copolymers are available in several different formulations from Kraton Polymers U.S., LLC, of Houston, Tex. under the trade designation KRATON®. Other commercially available block copolymers include the SEPS or styrene-poly(ethylene-propylene)-styrene elastic copolymer available from Kuraray Company, Ltd. of Okayama, Japan, under the trade name SEPTON®.

Examples of elastic polyolefins include ultra-low density elastic polypropylenes and polyethylenes, such as those produced by “single-site” or “metallocene” catalysis methods. Such polymers are commercially available from the Dow Chemical Company of Midland, Mich. under the trade name ENGAGE®, and described in U.S. Pat. Nos. 5,278,272 and 5,272,236 to Lai et al. entitled “Elastic Substantially Linear Olefin Polymers”. Also useful are certain elastomeric polypropylenes such as are described, for example, in U.S. Pat. No. 5,539,056 to Yang et al. and U.S. Pat. No. 5,596,052 to Resconi et al., incorporated herein by reference in their entireties, and polyethylenes such as AFFINITY® EG 8200 from Dow Chemical of Midland, Mich. as well as EXACT® 4049, 4011 and 4041 from the ExxonMobil Chemical Company of Houston, Tex., as well as blends.

While not described in detail herein, various additional potential constructional elements or features may be used without departing from the spirit and scope of the invention. For example, a second reservoir and/or series of individually openable reservoirs may be added to the fabric cleaning article, or, alternatively, the reservoir described hereinabove may be compartmentalized into individual smaller reservoirs. Such additional or compartmentalized reservoirs may comprise additional cleaning composition and/or cleaning of multiple smaller spots, and/or different types of cleaning composition, and/or rinsing agents or water for rinsing of the cleaned fabric spot. In addition, various additional processing and/or finishing steps as are known in the art for processing of fibrous web materials and film materials may be performed on the fabric cleaning article and/or on the component materials of the fabric cleaning article without departing from the spirit and scope of the invention.

Examples of additional processing include such as the application of treatments, printing of graphic designs or company logos or suggested user instructions, or further lamination of the fabric cleaning article or component layers thereof with other materials, such as additional film or fibrous material backing or facing layers, may be performed without departing from the spirit and scope of the invention. General examples of material treatments include one or more treatments to impart or increase wettability or hydrophilicity to a web material. Wettability treatment additives may be incorporated into a polymer melt as an internal treatment during the production of an individual component material layer, or may be added topically at some point following the formation of an individual component material layer. As a specific example of the above-mentioned printing of graphic designs or suggested user instructions, one of the surfaces of the reservoir may be printed with a “target zone” such as concentric circles in a bull's-eye pattern, crossed lines, etc., that act as an aid to the user in placing the delivery area of the reservoir directly over the spot or stain. This type of graphic is particularly useful where the material of the reservoir (and barrier layer, if coextensive across the reservoir) is a transparent material.

### EXAMPLE

A sample fabric cleaning article was constructed as follows. The sample fabric cleaning article was configured very similarly to the fabric cleaning article described above with respect to FIG. 4, except for modifications which will be noted here, and FIG. 4 will be used for reference. The sample fabric cleaning article was constructed having a first absorbent layer and second absorbent layer which were each about 6 inches wide by about 9 inches tall (about 15.24 centimeters wide by about 22.86 centimeters tall). The two absorbent layers were placed adjacent to one another (that is, side-by-side) with a 9 inch (22.86 centimeter) side of each absorbent layer adjacent to the other. These two absorbent layers were each coform materials available from the Kimberly-Clark Corporation, Dallas, Tex. Each coform layer was made from approximately 35 percent by weight of polypropylene meltblown and approximately 65 percent by weight cellulosic fibers which were wood pulp fibers, and each had a basis weight of approximately 267 grams per square meter or gsm.

The reservoir and liquid barrier layer were constructed using a commercially available polyethylene 2-gallon sized bag. To construct the reservoir, bag was laid out flat and a commercially available 12 inch (about 30 centimeter) electrical impulse sealer from Harbor Freight Tools, Camarillo, Calif. was used to seal the polyethylene bag to itself along 3 straight lines forming 3 sides of a rectangle. Unlike the reservoir shown in FIG. 4 which is shown to be as tall as the entire fabric cleaning article, the reservoir in the sample fabric cleaning article was only about 4.5 inches tall (about 11.43 centimeters tall) and was about 3 inches (about 7.62 centimeters) wide. The reservoir was centered from top to bottom such that several inches of bag material at the top and bottom of the reservoir area remained. Then, pinholes were placed through one surface of the reservoir area of the bag by hand using an office thumbtack having about a 0.045 inch (1.14 millimeter) diameter shaft. Twenty-four pinholes were placed in pattern that was approximately 2 inches (about 5 centimeters) in diameter by making 5 horizontal rows of pinholes. In the top row, 4 pinholes were placed along a horizontal line, with 5 offset pinholes along a horizontal line below the top row of 4 pinholes, 6 offset pinholes in the next lower row, then 5 offset pinholes in the next lower row, then finally 4 offset pinholes as the bottom row of pinholes.

The pinholed area of the reservoir was covered with an adhesive tape that was about 3 inches wide by about 4.5 inches tall (about 7.62 centimeters by 11.43 centimeters) and having a non-adhesive grip tab at one end of the tape that was approximately 1 centimeter tall. Then, the reservoir was filled with approximately 25 grams (approximately 25 milliliters) of a commercially available water-based carpet cleaning composition containing 2-butoxyethanol sold under the name SPOT SHOT® and available from The WD-40 Company of San Diego, Calif. The reservoir was completed by sealing the fourth side with the above-mentioned electrical impulse sealer.

The two absorbent layers were secured to the bag using a hot melt adhesive. As viewed with respect to FIG. 4, the second absorbent layer coform layer was placed on the far left end of the flattened bag, with the first absorbent layer coform layer placed to the right of the second absorbent layer (and next to the reservoir). The sample fabric cleaning article was then tested on a carpet. The pinholes through the polymer film bag were small enough such that, when the peel-away tape cover was not in place over the pinholes, the cleaning composition did not escape through the pinholes. However, when pressure was applied by pressing with a foot on the opposite side of the reservoir, the cleaning composition was forcefully expressed into the carpet with a mild “jetting” action. The position of the fabric cleaning article was then adjusted to place the absorbent material over the area of carpet treated with the cleaning composition and pressure was applied to the back of the liquid barrier layer bag material with the foot, and this process was repeated several times to reposition dry portions of the absorbent material over the treated area. The absorbent material visually picked up soils and debris from the carpet along with absorbing up the cleaning composition.

The embodiments of the fabric cleaning article described herein are highly suited for use as hand held and hand-activated and/or foot-activated cleaning article for use in household, commercial or industrial cleaning of fabrics which have become soiled or stained. The fabric cleaning article may desirably be used to remove spots or stains from such fabrics as clothing, upholstery and carpeting, etc., and provides for mess-free and convenient all-in-one cleaning.

While various patents have been incorporated herein by reference, to the extent there is any inconsistency between incorporated material and that of the written specification, the written specification shall control. In addition, while the invention has been described in detail with respect to specific embodiments thereof, it will be apparent to those skilled in the art that various alterations, modifications and other changes may be made to the invention without departing from the spirit and scope of the present invention. It is therefore intended that the claims cover all such modifications, alterations and other changes encompassed by the appended claims.

1. An all-in-one fabric cleaning article comprising at least a first absorbent layer having an upper surface and a lower surface, at least one reservoir adjacent said first absorbent layer, said reservoir comprising a cleaning composition, and at least one liquid barrier layer, said at least one liquid barrier layer secured to said upper surface of said at least first absorbent layer and secured to said at least one reservoir.

2. The fabric cleaning article of claim 1 wherein said at least first absorbent layer comprises a nonwoven web material.

3. The fabric cleaning article of claim 2 wherein said nonwoven web material comprises cellulosic fibers and thermoplastic polymer fibers.

4. The fabric cleaning article of claim 3 wherein said nonwoven web material comprises a coform material.

5. The fabric cleaning article of claim 3 wherein said nonwoven web material comprises an airlaid material.

6. The fabric cleaning article of claim 3 wherein said nonwoven web material is a laminate material further comprising a facing layer.

7. The fabric cleaning article of claim 1 further comprising a second absorbent layer having an upper surface and a lower surface, said liquid barrier layer secured to said second absorbent layer.

8. The fabric cleaning article of claim 7 wherein said second absorbent layer comprises a nonwoven web material.

9. The fabric cleaning article of claim 8 wherein said liquid barrier layer is secured to said upper surface of said second absorbent layer.

10. The fabric cleaning article of claim 8 wherein said liquid barrier layer is secured to said lower surface of said second absorbent layer.

11. The fabric cleaning article of claim 10 wherein said liquid barrier layer comprises a first section and a second section, said first section secured to said first absorbent layer and said second absorbent layer, and said second section of said liquid barrier layer is positionable against said lower surface of said first absorbent layer and against said upper surface of said second absorbent layer.

12. The fabric cleaning article of claim 9 wherein said fabric cleaning article is provided in a Z-fold configuration.

13. The fabric cleaning article of claim 1 wherein said reservoir comprises a peel-away cover.

14. The fabric cleaning article of claim 9 wherein said reservoir comprises a peel-away cover.

15. The fabric cleaning article of claim 10 wherein said reservoir comprises a peel-away cover.

16. The fabric cleaning article of claim 9 wherein said first absorbent layer comprises a nonwoven web material.

17. The fabric cleaning article of claim 16 wherein at least one of said first absorbent layer and said second absorbent layer is a laminate material further comprising a facing layer.

18. The fabric cleaning article of claim 10 wherein said first absorbent layer comprises a nonwoven web material.

19. The fabric cleaning article of claim 18 wherein at least one of said first absorbent layer and said second absorbent layer is a laminate material further comprising a facing layer.

20. The fabric cleaning article of claim 1 wherein at least a portion of said reservoir is formed from said liquid barrier layer.
